(19) United States
(12) Patent Application Publication
(10) Pub. No.: US 2017/0065885 A1
(43) Pub. Date: Mar. 9, 2017

(54) INFORMATION PROCESSING SERVER AND METHOD FOR GAMEPLAY

(71) Applicant: SONY CORPORATION, Tokyo (JP)

(72) Inventors: SHUNSUKE KUNIEDA, SAN FRANCISCO, CA (US); MICHELLE DOWNES, SAN FRANCISCO, CA (US); WIVAT KRUAWONGWANICH, SAN FRANCISCO, CA (US)

(21) Appl. No.: 15/255,730

(22) Filed: Sep. 2, 2016

Related U.S. Application Data
(60) Provisional application No. 62/214,459, filed on Sep. 4, 2015.

(51) Int. Cl. A63F 13/35; A63F 13/32; A63F 13/86; A63F 13/33; A63F 13/335; A63F 13/25; A63F 13/327

(52) U.S. Cl. CPC A63F 13/35; A63F 13/25; A63F 13/32; A63F 13/327; A63F 13/33; A63F 13/335; A63F 13/86; A63F 2300/407; A63F 2300/405

(57) ABSTRACT

Various aspects of an information processing server and method for gameplay are disclosed herein. The information processing server includes one or more circuits configured to enable viewing of a game, on a first electronic device associated with a first user, currently being played by one or more other users associated with one or more other electronic devices. The one or more circuits are further configured to enable direct joining of the game by the first electronic device for gameplay with the one or more other users associated with the one or more other electronic devices without requiring any input from the one or more other users associated with the one or more other electronic devices. The direct joining of the game may be enabled based on a request received from the first user by the first electronic device.

### CROSS-REFERENCE TO RELATED APPLICATIONS/INCORPORATION BY REFERENCE

This application claims priority to U.S. Provisional Patent Application Ser. No. 62/214,459 filed on Sep. 4, 2015, the entire content of which is hereby incorporated by reference.

### FIELD

Various embodiments of the disclosure relate to an information processing server for gameplay. More specifically, various embodiments of the disclosure relate to an information processing server and method for gameplay based on a view of games played by one or more users in an online gaming environment.

### BACKGROUND

Recent advancements in the field of gaming systems have led to the development of various methods and techniques to provide a gaming platform to play a game with multiple users in an online gaming environment. Typically, for a user to join the gameplay of the game in the online gaming environment, the user transmits a request to other users, who are currently visible as online in the gaming platform in the online gaming environment. It may be difficult for the user to find out if the other users who are visible as online are actually playing games in the online gaming environment. It may also be difficult for the user to find out which games are currently played by the friends of the user or other members. Such online gaming environment may fail to provide a user-friendly, effective, and efficient environment for the gameplay of the game with multiple users. It may not be desirable for a user to acknowledge multiple requests or grant permissions to let other users join the gameplay. Such multiple request from a single or multiple users, and lack of readily usable information to decide to whom to play with, may increase dissatisfaction and annoyance among the users.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An information processing server and method are provided for gameplay substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for gameplay in an online gaming environment, in accordance with an embodiment of the disclosure.

FIG. 2 is a block diagram that illustrates an information processing server for gameplay in an online gaming environment, in accordance with an embodiment of the disclosure.

FIG. 3 is a block diagram that illustrates an exemplary electronic device, in accordance with an embodiment of the disclosure.

FIGS. 4A, 4B, and 4C are block diagrams that illustrate exemplary scenarios and exemplary user interfaces for implementation of the disclosed information processing server and method for gameplay in an online gaming environment, in accordance with an embodiment of the disclosure.

FIG. 5 is a flow chart that illustrates an information processing method for gameplay in an online gaming environment, in accordance with an embodiment of the disclosure.

### DETAILED DESCRIPTION

Various implementations may be found in an information processing server and method for gameplay in an online gaming environment. Exemplary aspects of the disclosure may comprise a method implemented in an information processing server that may include one or more circuits. The information processing method may enable, for example, allow or permit, a first user to view a game on a first electronic device associated with the first user, wherein the game is currently being played by one or more other users. The one or more other users may be associated with one or more other electronic devices. The information processing method may further enable direct joining of the game by the first electronic device for the gameplay with the one or more other users associated with the one or more other electronic devices. The direct joining of the game by the first electronic device for the gameplay may be enabled based on a request received from the first user by the first electronic device. The received request may comprise a request to join the game for the gameplay with the one or more other users.

In accordance with an embodiment, the direct joining may be enabled, for example, allow or permit, without requiring any input from the one or more other users. In this regard, the first electronic device may directly join the gameplay with the one or more other users independent of requiring from, and/or receiving any input from the one or more other users. The information processing method may further establish a game session between the first electronic device and the one or more other electronic devices for the gameplay based on the received request to join the game.

In accordance with an embodiment, a viewing request to view the gameplay of the game of the one or more other users may be further received. Based on the received viewing request, the gameplay of the game of the one or more other users may be displayed on the first electronic device. In accordance with an embodiment, the gameplay of the game of the one or more other users may be displayed on the first electronic device as a screenshot. In accordance with another embodiment, the gameplay of the game of the one or more other users may be displayed on the first electronic device as a broadcast video.

In accordance with an embodiment, an online status of the one or more other users associated with the game may be indicated on the first electronic device. A progress of the one or more other users associated with the game may be indicated on the first electronic device. Further, a community associated with the first user may be displayed on the first electronic device. In accordance with an embodiment, one or more games may be sorted based on a session creation time of the one or more games. Parental control options to display content of the game may also be provided on the first electronic device.

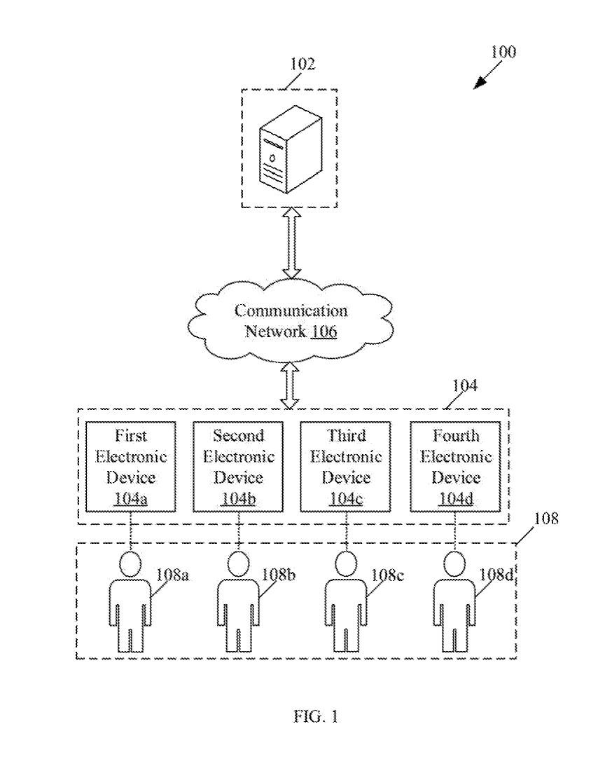

FIG. 1 is a block diagram that illustrates an exemplary network environment for gameplay in an online gaming environment, in accordance with an embodiment of the disclosure. With reference to FIG. 1, there is shown an exemplary network environment 100. The exemplary network environment 100 may include one or more cloud resources, such as a server 102, a plurality of electronic devices 104, such as a first electronic device 104a, a second electronic device 104b, a third electronic device 104c, and a fourth electronic device 104d, and a communication network 106. There is further shown a plurality of users 108, such as a first user 108a, a second user 108b, a third user 108c, and a fourth user 108d, who are associated with the first electronic device 104a, the second electronic device 104b, the third electronic device 104c, and the fourth electronic device 104d, respectively as shown. With reference to FIG. 1, the plurality of electronic devices 104 may be communicatively coupled to the server 102, via the communication network 106.

The server 102 may comprise suitable logic, circuitry, interfaces, and/or code that may be configured to communicate with the plurality of electronic devices 104 associated with the plurality of users 108, via the communication network 106. The server 102 may be further configured to enable direct joining of a game by the first electronic device 104a associated with the first user 108a for gameplay with one or more other users 108b to 108d. The one or more other users 108b to 108d (such as the second user 108b, the third user 108c, and the fourth user 108d) may be associated with one or more other electronic devices 104b to 104d (such as the second electronic device 104b, the third electronic device 104c, and the fourth electronic device 104d), respectively. Examples of the server 102 may include, but are not limited to, a cloud server, an application server, a database server, a web server, or a combination thereof. The server 102 may be implemented by use of several technologies that are well known to those skilled in the art.

Each of the plurality of electronic devices 104 may comprise suitable logic, circuitry, interfaces, and/or code that may be configured to communicate with the server 102, via the communication network 106. A user, such as the first user 108a, may utilize an electronic device, such as the first electronic device 104a, to view and/or play the game that is currently being played by the one or more other users 108b to 108d. Examples of the plurality of electronic devices 104 may include, but are not limited to, a desktop computer, a smart phone, a camera, a tablet computer, a laptop, a gaming device, a wearable electronic device, and/or other such computing devices.

The communication network 106 may include a communication medium through which the server 102 may communicate with the plurality of electronic devices 104. The communication network 106 may be a wired or wireless communication network. Examples of the communication network 106 may include, but are not limited to, a Wireless Fidelity (Wi-Fi) network, a Local Area Network (LAN), a wireless personal area network (WPAN), a Wireless Local Area Network (WLAN), a wireless wide area network (WWAN), a cloud network, a Long Term Evolution (LTE) network, a plain old telephone service (POTS), a Metropolitan Area Network (MAN), and/or the Internet. Various devices in the exemplary network environment 100 may be configured to connect to the communication network 106, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, Long Term Evolution (LTE), Light Fidelity (Li-Fi), and/or other cellular communication protocols or Bluetooth (BT) communication protocols, including variants thereof.

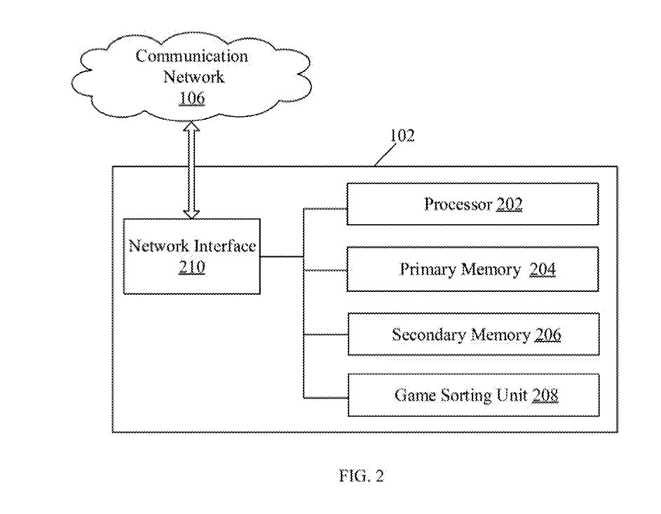

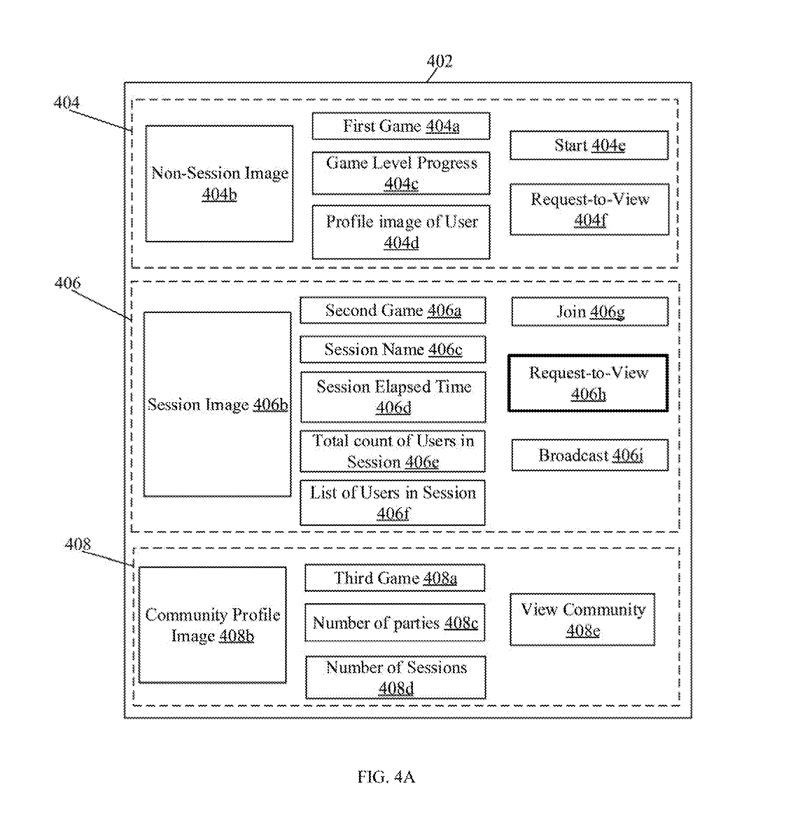

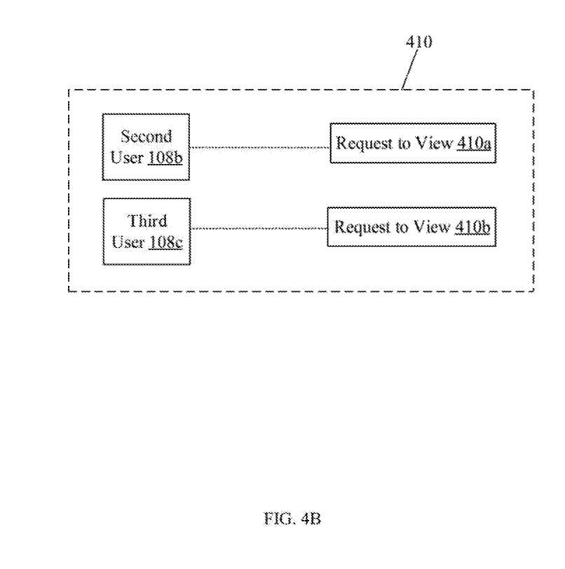

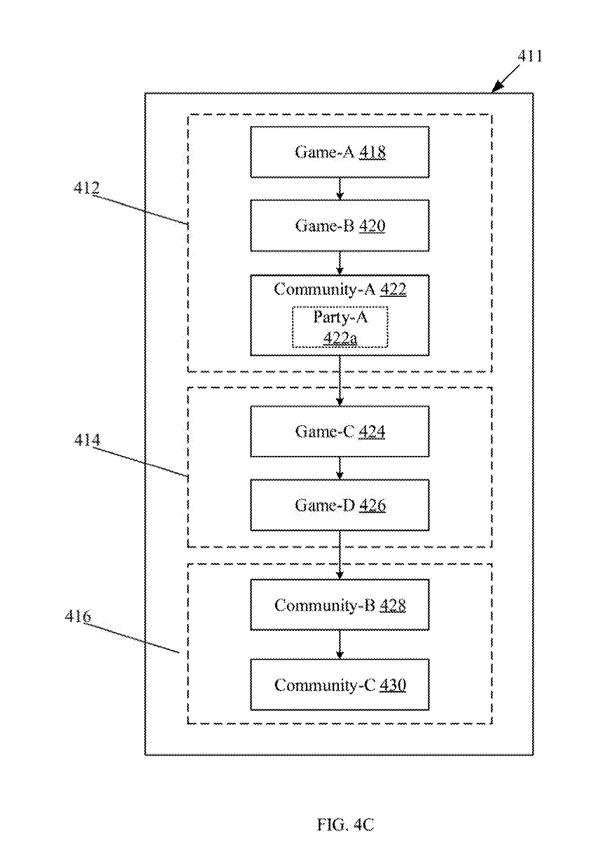

In operation, the server 102 may receive a request from one of the plurality of electronic devices 104, such as the first electronic device 104a associated with the first user 108a, via the communication network 106. The received request may comprise a request to view one or more games that are currently played by the one or more other users 108b to 108d. The server 102 may be configured to sort a plurality of games that may include the one or more games currently being played by the one or more other users 108b to 108d. The server 102 may sort the plurality of games based on a session creation time of the plurality of games to determine a sorted order of the one or more games. The plurality of games may be sorted in certain order and/or grouped based on certain parameters, such as games associated with open sessions, community games, and/or alphabetical order of a game title of the plurality of games. The sorting operation of the plurality of games is further described in details, for example, in FIG. 2 and FIG. 4C.

The server 102 may be configured to enable the plurality of users 108, such as the first user 108a, to view the one or more games that are currently played by the one or more other users 108b to 108d. For example, the server 102 may enable the first user 108a associated with the first electronic device 104a to view a game that is currently played by the one or more other users 108b to 108d, such as the second user 108b, the third user 108c, and the fourth user 108d. The second user 108b, the third user 108c, and the fourth user 108d may be associated with the second electronic device 104b, the third electronic device 104c, and the fourth electronic device 104d, respectively. The server 102 may be configured to display the one or more games, currently being played by the one or more other users 108b to 108d, in the determined sorted order on the first electronic device 104a.

The server 102 may be further configured to receive a request from the first electronic device 104a associated with the first user 108a, via the communication network 106. The received request may comprise a request to join a game for gameplay with the one or more other users 108b to 108d. The game may correspond to one of the one or more games that may be then played by the one or more other users 108b to 108d. Based on the received request, the server 102 may be further configured to enable direct joining of the game by the first electronic device 104a for the gameplay with the one or more other users 108b to 108d associated with the one or more other electronic devices 104b to 104d. In accordance with an embodiment, the server 102 may enable the direct joining of the game by the first electronic device 104a without requiring any input from the one or more other users 108b to 108d. The server 102 may be configured to establish a game session between the first electronic device 104a and the one or more other electronic devices 104b to 104d for the gameplay based on the received request to join the game. The game may then be played by the first user 108a with the one or more other users 108b to 108d on the first electronic device 104a.

FIG. 2 is a block diagram that illustrates an information processing server for gameplay in an online gaming environment, in accordance with an embodiment of the disclosure. FIG. 2 is described in conjunction with elements from FIG. 1. With reference to FIG. 2, there is shown a block diagram of an exemplary information processing server, such as the server 102. The server 102 may include one or more circuits, such as a processor 202, a primary memory 204, a secondary memory 206, a game sorting unit 208, and a network interface 210. With reference to FIG. 2, there is further shown the communication network 106 (FIG. 1).

In accordance with an embodiment, the processor 202 may be communicatively coupled to the primary memory 204, the secondary memory 206, the game sorting unit 208, and the network interface 210. The network interface 210 may be configured to communicate with the plurality of electronic devices 104, via the communication network 106.

The processor 202 may comprise suitable logic, circuitry, interfaces, and/or code that may be configured to execute a set of instructions stored in the primary memory 204 and/or the secondary memory 206. The processor 202 may be further configured to enable direct joining of a game by the first electronic device 104a for gameplay with the one or more other users 108b to 108d. The processor 202 may be implemented based on a number of processor technologies, which are known in the art. Examples of the processor 202 may be an X86-based processor, a Reduced Instruction Set Computing (RISC) processor, an Application-Specific Integrated Circuit (ASIC) processor, a Complex Instruction Set Computing (CISC) processor, and/or other processors or control circuits.

The primary memory 204 may comprise suitable logic, circuitry, interfaces, and/or code that may be configured to temporarily store data that corresponds to one or more games that are currently being played by the one or more other users 108b to 108d. The one or more other users 108b to 108d, such as the second user 108b, the third user 108c, and the fourth user 108d, may utilize the one or more other electronic devices 104b to 104d respectively, to play the one or more games over the communication network 106. Examples of implementation of the primary memory 204 may include, but are not limited to, Random Access Memory (RAM), Dynamic Random Access Memory (DRAM), Static Random Access Memory (SRAM), Thyristor Random Access Memory (T-RAM), Zero-Capacitor Random Access Memory (Z-RAM), cache memory, and/or other volatile memory.

The secondary memory 206 may comprise suitable logic, circuitry, interfaces, and/or code that may be configured to store a machine code and/or a set of instructions executable by the processor 202. The secondary memory 206 may be configured to store one or more sorting algorithms that are executed by the processor 202 to sort the one or more games. The secondary memory 206 may be further configured to store operating systems and associated applications of the server 102. Examples of implementation of the secondary memory 206 may include, but are not limited to, Read Only Memory (ROM), a flash memory, Hard Disk Drive (HDD), a Solid-State Drive (SSD), a Secure Digital (SD) card, and/or a removable media drive.

The game sorting unit 208 may comprise suitable logic, circuitry, interfaces, and/or code that may be configured to generate a sorted order of the plurality of games. The plurality of games may include the one or more games that may be currently played by the one or more other users 108b to 108d. The game sorting unit 208 may be configured to sort the plurality of games based on at least a session creation time of the plurality of games to generate the sorted order of the plurality of games. The game sorting unit 208 may be implemented as a separate processor or circuitry in the server 102. The game sorting unit 208 and the processor 202 may be implemented as an integrated processor or a cluster of processors that perform the functions of the game sorting unit 208 and the processor 202. The game sorting unit 208 may be implemented as a set of instructions stored in the secondary memory 206, which on execution by the processor 202 may perform the functions and operations of the server 102.

The network interface 210 may comprise suitable logic, circuitry, interfaces, and/or code that may be configured to communicate with the information processing server, such as the server 102 (as shown in FIG. 1), via the communication network 106 (as shown in FIG. 1). The network interface 210 may be implemented by use of known technologies to support wired or wireless communication of the server 102 with the communication network 106. Components of the network interface 210 may include, but are not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

In operation, the processor 202 may be configured to receive a request from one of the plurality of electronic devices 104, via the communication network 106. For example, the processor 202 may receive the request from the first electronic device 104a associated with the first user 108a, via the communication network 106. The received request may comprise a request to view one or more games that are currently played by the one or more other users 108b to 108d, such as the second user 108b, the third user 108c, and the fourth user 108d. For instance, the one or more other users 108b to 108d may be friends of the first user 108a. In another instance, the one or more other users 108b to 108d may be acquaintances of the first user 108a. In yet another instance, the one or more other users 108b to 108d may be followers of the first user 108a as registered at the server 102.

The processor 202 may render a user interface (UI) on a display screen (not shown) of the first electronic device 104a in response to the received request via the communication network 106. The processor 202 may further display the plurality of games that includes the one or more games associated with one or more game sessions in a sorted order on the rendered UI. The one or more game sessions may correspond to a non-session game, a session game, or a community game. The non-session game may refer to a game that is currently played by the one or more other users 108b to 108d, independent of each other, on their respective one or more other electronic devices 104b to 104d. For instance, two users, such as a user “X” and a user “Y”, are playing a game, such as a game “Z”, on their respecting electronic devices independent of each other. In other words, the user “X” and the user “Y” may not be competing with each other, while they are playing the game “Z”. In such a scenario, the game “Z” may correspond to the non-session game. The session game may refer to a game that is currently played by multiple users in an established game session. For instance, two users, such as a user “X” and a user “Y”, are playing a game, such as a game “ZZ”, on their respecting electronic devices. Further, the user “X” is playing the game “ZZ” against the user “Y”. For instance, the user “X” and the user “Y” may be competing with each other, while they are playing the game “ZZ”. In such a scenario, the game “ZZ” may correspond to the session game. Further, the community game may refer to a game that may be associated with a similar level of preferences in a game choice by multiple users. The community game may also include one or more game sessions that are associated with the one or more games currently played by the one or more other users 108b to 108d.

In accordance with an embodiment, prior to the display of the sorted order of the plurality of games on the UI, the game sorting unit 208 may be configured to sort the plurality of games that includes the one or more games. The plurality of games may be grouped to a first set of games, a second set of games, and a third set of games. The first set of games may comprise games with the one or more game sessions that may have open sessions. The second set of games may comprise games associated with the one or more game sessions that may indicate a presence of the one or more other users 108b to 108d. The third set of games may comprise one or more community games that are not bound to a particular game. Thereafter, the game sorting unit 208 may be configured to generate the sorted order of the plurality of games.

The game sorting unit 208 may rank the games in the first set of games at top, followed by the games in the second set of games and the third set of games. The game sorting unit 208 may be configured to sort the games in the first set of games based on a session creation time of each game in the first set of games. For instance, the game sorting unit 208 may sort the games in order of most recently started games. For example, game “A” may be started before game “B”. In such a case, the game “B” is ranked at top. In other words, the game “A” is ranked below the game “B” in a sorted order.

The game sorting unit 208 may sort the games in the second set of games based on an alphabetical order of game titles of the games in the second set of games. The presence of the one or more other users 108b to 108d associated with the games in the second set of games may be displayed in an alphabetical order of user's online identifier. The game sorting unit 208 may sort the games in the third set of games based on the number of online users in each game or community, and/or alphabetical order of game or community titles. After the generation of the sorted order of the plurality of games, the processor 202 may display the plurality of games that includes the one or more games on the UI.

The processor 202 may further include additional information of the one or more games displayed on the UI. For instance, the rendered UI may include a game title, a game thumbnail, a profile image, a total count of users in a game session, a list of users in the game session, an elapsed time in a game session, and/or the like. The game title may correspond to a name of a game that is currently played by the one or more other users 108b to 108d. In another instance, the game title may correspond to the name of the one or more games that may be associated with the first user 108a, for example, the one or more games registered by the first user 108a. The game thumbnail may correspond to a still image of the one or more games. In another instance, the game thumbnail may correspond to a video of the one or more games. The profile image may correspond to an image of a user, who may be associated with the one or more games. For instance, the profile image may correspond to the image of one of the one or more other users 108b to 108d, who are currently playing the one or more games. In another instance, the profile image may further correspond to an image that is representative of the community game associated with the first user 108a. The total count of users in the game session may correspond to a number of users, who may be currently playing the one or more games in the game session. The list of users in the game session may correspond to a list of users, such as the one or more other users 108b to 108d, who are currently playing the one or more games in the game session. The elapsed time in the game session may correspond to a time duration of the game session that has been already elapsed in the gameplay of the one or more games associated with the game session.

The processor 202 may further display a progress of the one or more other users 108b to 108d in the gameplay of the one or more games on the UI. The processor 202 may also display a number of parties and a number of game sessions associated with the community game on the UI. One or more UI elements, such as input tabs, may be rendered on the UI to enable the plurality of users 108, such as the first user 108a, to provide their preferences for the one or more games associated with the one or more game sessions. For example, the one or more input tabs may include a start input tab, a request-to-view input tab, a join input tab, a broadcast input tab, and a view community input tab. The functions of the one or more input tabs are described, for example, in FIGS. 4A, 4B, and 4C.

The processor 202 may further enable the plurality of users 108, such as the first user 108a, to view the one or more games that are currently played by the one or more other users 108b to 108d. It may be convenient for the first user 108a to view the additional information associated with the one or more games rendered on the UI on the first electronic device 104a. The first user 108a may then make an informed decision to play with a certain user of choice.

The processor 202 may be further configured to receive a request from one of the plurality of electronic devices 104 associated with the plurality of users 108, via the communication network 106. For example, the processor 202 may receive the request from the first electronic device 104a associated with the first user 108a, via the communication network 106. The received request may comprise a request to join a game for gameplay with the one or more other users 108b to 108d, who may be then playing the game. The one or more other users 108b to 108d may be playing the game on their respective one or more other electronic devices 104b to 104d. Based on the received request to join the game, the processor 202 may be further configured to enable a direct joining of the game by the first electronic device 104a associated with the first user 108a. The direct joining enables the first user 108a to start gameplay of the game instantly with the one or more other users 108b to 108d. In accordance with an embodiment, the direct joining of the game for the gameplay may be enabled without requiring any input from the one or more other users 108b to 108d. The processor 202 may establish a game session between the first electronic device 104a associated with first user 108a and the one or more other electronic devices 104b to 104d. The processor 202 may establish the game session based on the received request to join the game for the gameplay.

The processor 202 may further receive a request from one of the plurality of electronic devices 104 associated with the plurality of users 108, via the communication network 106. For example, the processor 202 may receive the request from the first electronic device 104a associated with the first user 108a, via the communication network 106. The received request may comprise a request to view the gameplay of the game of the one or more other users 108b to 108d. In response to the received viewing request, the processor 202 may display the gameplay of the game of the one or more other users 108b to 108d on the first electronic device 104a associated with the first user 108a. The processor 202 may display the gameplay of the game of the one or more other users 108b to 108d as a screenshot or broadcast video on the display screen of the first electronic device 104a associated with first user 108a.

The processor 202 may further display an online status of the one or more other users 108b to 108d, who are currently playing the game. The online status of the one or more other users 108b to 108d may be displayed on the display screen of the first electronic device 104a associated with the first user 108a. The online status may be indicative of a current gameplay status of the one or more other users 108b to 108d in the game. For instance, the online status may correspond to an availability or unavailability of the one or more other users 108b to 108d in the gameplay of the game. The processor 202 may indicate the online status of the one or more other users 108b to 108d by use of a visual and/or audible cue. For example, the processor 202 may indicate the online status of the one or more other users 108b to 108d by use of an indicator displayed on the display screen of the first electronic device 104a. For example, the processor 202 may display the indicator with different colors to display different status of the one or more other users 108b to 108d. For instance, the indicator with “green” color may indicate that the one or more other users 108b to 108d are currently available and playing the game. In another instance, the indicator with “red” color may indicate that the one or more other users 108b to 108d are currently unavailable for the gameplay of the game. In accordance with another embodiment, the processor 202 may indicate the online status of the one or more other users 108b to 108d via textual information displayed on the display screen of the first electronic device 104a.

The processor 202 may further display a progress of the one or more other users 108b to 108d in the game that is currently being played by the one or more other users 108b to 108d. The progress of the one or more other users 108b to 108d in the game may be displayed on the display screen of the first electronic device 104a associated with the first user 108a. For instance, the progress of the one or more other users 108b to 108d in the game may indicate a number of stages of the game completed by the one or more other users 108b to 108d. In another instance, the progress of the one or more other users 108b to 108d in the game may indicate a number of attempts by the one or more other users 108b to 108d to complete each stage of the game. The progress of the one or more other users 108b to 108d in the game may further indicate time taken by the one or more other users 108b to 108d to complete each stage of the game. In yet another instance, the progress of the one or more other users 108b to 108d in the game may indicate a remaining time to complete remaining stages of the game.

In accordance with an embodiment, the processor 202 may be further configured to generate a blurred video of the game in the background of the UI. The blurred video may be generated based on defined settings. For example, an age limit, geographical restrictions, and/or other defined limits or restrictions settings. For example, certain games may be appropriate for a certain age group, such as above 16 years. Again, certain games are suitable for kids, such as for age group of 8-12 years, or teen users, such as 15-19 years. Thus, age limit restrictions may be applied according to the defined age of a user in the user profile. Further, inappropriate content in the games may be blurred for users not suitable as per their age group. The age restrictions may also be referred to as age gating. With regards to age limit restrictions, the processor 202 may further provide parental control options to display certain content of the game on the first electronic device 104a. For example, the game thumbnails of the one or more games for age restricted users may be displayed on the display screen of the plurality of electronic devices 104. The processor 202 may further deny age restricted users to view the one or more games based on the defined settings. Geographical restrictions may be bound to certain games. Certain games may be visible and available to play in certain geographical areas, such as a country, and may not be made available in other countries. In accordance with an embodiment, age restrictions or geographical restrictions may not be imposed by the processor 202 for request-to-view tabs, such as the request-to-view tab 406h. The processor 202 may further enable the plurality of users 108, such as the first user 108a, to play the one or more games in a private mode. The private mode may enable the first user 108a to avoid the sharing of games earnings, such as game trophies or coins, with the one or more other users 108b to 108d.

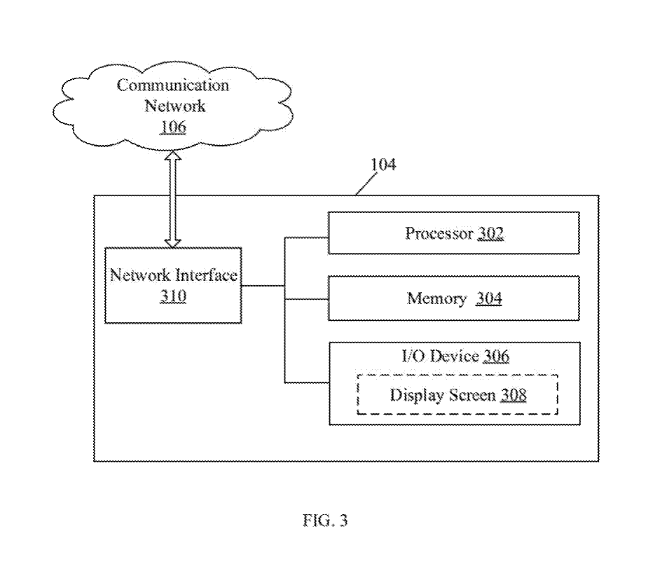

FIG. 3 is a block diagram that illustrates an exemplary electronic device, in accordance with an embodiment of the disclosure. FIG. 3 is described in conjunction with elements from FIG. 1 and FIG. 2. With reference to FIG. 3, there is shown a block diagram that corresponds to, an exemplary electronic device, such as the first electronic device 104a. The first electronic device 104a may include one or more circuits that may enable the first user 108a to interact with the server 102 or the one or more other users 108b to 108d, via the communication network 106. The one or more circuits may include a processor 302, a memory 304, an input/output (I/O) device 306, and a network interface 310. The I/O device 306 may further comprise a display screen 308. With reference to FIG. 3, there is further shown the communication network 106 (FIG. 1).

In accordance with an embodiment, the processor 302 may be communicatively coupled to the memory 304, the I/O device 306, the display screen 308, and the network interface 310. The network interface 310 may be configured to communicate with the server 102 and/or the one or more other electronic devices 104b to 104d, via the communication network 106.

The processor 302 may comprise suitable logic, circuitry, interfaces, and/or code that may be configured to execute a set of instructions stored in the memory 304. The processor 302 may be further configured to display one or more user interfaces, associated with one or more games, rendered by the processor 202. Examples of the implementation of the processor 302 may be similar to that of the processor 202 (FIG. 2).

The memory 304 may comprise suitable logic, circuitry, interfaces, and/or code that may be configured to store a machine code and/or a computer program with at least one code section executable by the processor 302. The memory 304 may be further configured to store operating systems and associated applications of the first electronic device 104a. Examples of implementation of the memory 304 may include, but are not limited to, Random Access Memory (RAM), Read Only Memory (ROM), Solid-state Drive (SSD), Hard Disk Drive (HDD), Flash memory, and/or a Secure Digital (SD) card.

The I/O device 306 may comprise suitable logic, circuitry, interfaces, and/or code that may be configured to receive an input from and provide an output to the first user 108a associated with the first electronic device 104a. Examples of the input devices may include, but are not limited to, a camcorder, a touch screen, a joystick, a microphone, a motion sensor, a gaming device, a light sensor, and/or a docking station. Examples of the output devices may include, but are not limited to, the display screen 308, a projector screen, and/or a speaker.

The network interface 310 may comprise suitable logic, circuitry, interfaces, and/or code that may be configured to communicate with an information processing server, such as the server 102 (as shown in FIG. 1), via the communication network 106 (as shown in FIG. 1). The network interface 310 may be implemented by use of known technologies to support wired or wireless communication of the first electronic device 104a with the communication network 106. The network interface 310 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

In operation, the plurality of users 108, such as the first user 108a, may utilize the I/O device 306 to provide one or more requests to the information processing server, such as the server 102, via the communication network 106. The network interface 310 may transmit a request under the control of the processor 302 to view one or more games that are currently played by the one or more other users 108b to 108d. In response to the transmitted request, the processor 302 may be configured to render the UI on the display screen 308, where the UI may include a sorted order of the plurality of games. The UI may further include additional information of the one or more games. For instance, the additional information may include a list of users in gameplay of the one or more games, a current stage in the gameplay of the one or more games, and a total count of users in the gameplay of the one or more games. The additional information may further include an online status of the one or more other users 108b to 108d in the gameplay of the one or more games, a progress of the one or more other users 108b to 108d in the gameplay of the one or more games, and/or the like.

After viewing the additional information, the first user 108a may provide an input by use of the I/O device 306, to transmit a request to join a game for gameplay with the one or more other users 108b to 108d. The first electronic device 104a may directly join the gameplay without requiring any input from the one or more other users 108b to 108d. In other words, the first electronic device 104a may directly join the gameplay independent of requiring any input to be may by or received from the one or more other users 108b to 108d. The first user 108a may play the game with the one or more other users 108b to 108d, over the communication network 106.

FIGS. 4A, 4B, and 4C are block diagrams that illustrate exemplary scenarios and user interfaces for implementation of the disclosed information processing server and method for gameplay in an online gaming environment, in accordance with an embodiment of the disclosure. FIGS. 4A, 4B, and 4C are described in conjunction with elements from the FIGS. 1, 2, and 3. With reference to FIG. 4A, there is shown a UI 402, which may be rendered on the display screen 308 of the first electronic device 104a. The UI 402 may include a non-session game section 404, a session game section 406, and a community game section 408, as shown in an example. Each game section may include various UI elements. The first user 108a, by use of the UI 402, may be able to see at a glance what other users, such as friends or friends circle members, are currently doing in the context of a game. The UI 402 may provide a platform to the first user 108a to quickly interact with other users. The information displayed on the UI 402 rendered on the first electronic device 104a may be dynamically updated in real time or near-real time by the server 102. The update may occur based on gameplay of the one or more other users 108b to 108d on their respective one or more other electronic devices 104b to 104d.

The non-session game section 404 may include various UI elements, such as a first game 404a, a non-session image 404b, a game level progress 404c, a profile image 404d, a start tab 404e and a request-to-view tab 404f. The session game section 406 may also include various UI elements, such as a second game 406a, a session image 406b of the second game 406a, a session name 406c of the second game 406a, a session elapsed time 406d, a total count of users in the session 406e, and a list of users in the session 406f. One or more input tabs, such as a join tab 406g, a request-to-view tab 406h, and a broadcast tab 406i, are also shown in the session game section 406. The community game section 408 may also include UI elements, such as a third game 408a, a community profile image 408b, a number of parties 408c, and a number of sessions 408d in the community game section 408. One or more input tabs, such as a view community tab 408e, is also shown in the community game section 408. The processor 202 may be configured to remotely display a game thumbnail associated with each of the one or more games on the UI 402 rendered on the first electronic device 104a. For instance, the game thumbnail associated with the non-session game section 404, the session game section 406, and the community game section 408 may be a still image or a video.

With reference to the non-session game section 404, the first game 404a may be a single player game. The non-session image 404b may be a game thumbnail of the first game 404a. The game thumbnail may be a still image or a video preview of a certain scene from the gameplay of the first game 404a. The processor 202 may be configured to enable display of the progress of the one or more other users 108b to 108d in the gameplay of a specific game in a non-session gameplay. For example, the game level progress 404c may indicate a progress in the gameplay of the first game 404a by the one or more other users 108b to 108d. The game level progress 404c may include progress information of the first game 404a, such as an elapsed time, an available time, a count of completed stages, a count of incomplete stages, and/or the like. The profile image 404d may provide a representative profile image of each of the plurality of users 108, such as the one or more other users 108b to 108d, currently playing the first game 404a independent of each other.

The one or more input tabs, such as the start tab 404e and the request-to-view tab 404f, may enable the first user 108a to take an action associated with the first game 404a. For example, the first user 108a may press the start tab 404e, to transmit a request, from the first electronic device 104a, to directly start the first game 404a. In response to the received request to directly start the first game 404a, the processor 202 may enable the first electronic device 104a to start gameplay of the first game 404a as a non-session gameplay. The first user 108a may click on an input tab, such as the request-to-view tab 404f, to transmit a request from the first electronic device 104a, to view the gameplay of the first game 404a by other users, such as the second user 108b, as a screenshot or broadcast video of the gameplay of the first game 404a.

With reference to the non-session game section 404, the second game 406a may be a multi-player game rendered as game title, such as “Shadow fall game”. The session image 406b of the second game 406a may be a game thumbnail that may represent an actual scene from an ongoing session of the second game 406a. The scene from the ongoing session may be rendered as a still image or a video. The session name 406c represents a name of the ongoing session or open sessions of the second game 406a. The session elapsed time 406d may indicate a time duration of the second game 406a that has elapsed in the gameplay of the second game 406a. The total count of users in the session 406e may indicate a numerical value that is representative of the total number of users, who may be currently playing the second game 406a. The list of users in the session 406f may provide a list of the one or more other users 108b to 108d, who are currently playing the second game 406a.

The processor 202 may be further configured to enable display of the one or more input tabs on the UI 402. For example, the first user 108a associated with the first electronic device 104a may provide an input on the join tab 406g, by use of the I/O device 306, of the first electronic device 104a. A request to join the gameplay of the second game 406a may be transmitted by the first electronic device 104a to the server 102. The processor 202 may enable the first electronic device 104a to directly join the second game 406a for the gameplay with the one or more other users 108b to 108d. The first user 108a may directly join the second game 406a from the current position or stage of the second game 406a as currently played by the one or more other users 108b to 108d. The processor 202 may be further configured to establish a game session between the first electronic device 104a and the one or more other electronic devices 104b to 104d. The first user 108a may further click on an input tab, such as the request-to-view tab 406h, to transmit a request, from the first electronic device 104a, to view the gameplay of the second game 406a currently played by the one or more other users 108b to 108d. The gameplay of an ongoing game session of the second game 406a may be viewed as a screen share, a screen shot, or a video. In accordance with an embodiment, the processor 202 may also highlight the broadcast tab 406i, to indicate an availability of the gameplay of the second game 406a as a live broadcast. The first user 108a may provide an input on the highlighted broadcast tab 406i, by use of the I/O device 306, to display the live broadcast of the gameplay of the second game 406a.

With reference to the community game section 408 of the UI 402, the third game 408a may be a game bound to a community. In accordance with an embodiment, certain communities may not be bound to a game. The UI element, such as the number of parties 408c, may indicate active parties. Active parties correspond to a party room in the online gaming environment with party members. Each community may have one or more sessions, as indicated by the number of sessions 408d. Each session may include one or more parties and each party may be associated with a game, such as the third game 408a, having similar preferences of multiple users. The first user 108a may further click on an input tab, such as the view community tab 408e, to view the community associated with the gameplay of the third game 408a. In response to the received request to view the community, the processor 202 may enable the first user 108a of the first electronic device 104a to view the one or more parties associated with the third game 408a. The one or more parties in the one or more sessions may be associated with the gameplay of a single game or multiple games. The processor 202 may enable the first user 108a to join the one or more sessions associated with the one or more parties for the gameplay of the third game 408a.

With reference to FIG. 4B, there is shown a UI 410 displayed on the display screen 308 of the first electronic device 104a associated with the first user 108a. The processor 202 may be configured to render the UI 410 in an event that an input is provided on the request-to-view tab 406h of the session game section 406 (FIG. 4A). A user, such as the first user 108a, may be able to request a screen share if there is an interesting ongoing gameplay in a session. The processor 202 may enable the first user 108a to view the gameplay of the second game 406a from the perspective of a specific user. For instance, the first user 108a associated with the first electronic device 104a may provide an input on the request-to-view tabs 410a to view to request a screen share of the gameplay of the second user 108b. The second user 108b may be registered as friend of the first user 108a and thus, may be ranked above the third user 108c in the displayed list of users that may be currently playing the second game 406a.

With reference to FIG. 4C, there is shown a sorted order of a plurality of games, such as games 418 to 426 and communities 428 and 430, rendered on a UI 411. The plurality of games 418 to 426 and communities 428 and 430 may be associated with the non-session game section 404, the session game section 406, and the community game section 408 (FIG. 4A). The game sorting unit 208 may be configured to group the plurality of games to a first set of games 412, a second set of games 414, and a third set of games 416.

The first set of games 412 may comprise games associated with the one or more game sessions that may have open sessions. The second set of games 414 may comprise games associated with the one or more game sessions that may indicate active presence of the one or more other users 108b to 108d for gameplay. The third set of games 416 may comprise one or more communities that may not be bound to a game. The game sorting unit 208 may be configured to rank the games in the first set of games 412 at top, followed by the games in the second set of games 414, further followed by the games in the third set of games 416. Thereafter, the game sorting unit 208 may sort the games in the first set of games 412. The games in first set of games may be sorted based on a session creation time of each game in the first set of games 412. For instance, the game sorting unit 208 may rank the most recently started games at top followed by previously started games. For example, the game-A 418 may be the most recently started game. Therefore, the game sorting unit 208 may rank the game-A 418 at top in the generated sorted order, as shown. The game-B 420 may be ranked after the game-A 418, as the game-B 420 may be started after the start of the game-A 418. The community-A 422 may be ranked below the game-B 420 in the first set of games 412 that includes games with open sessions. The community-A 422 may include the one or more parties, such as a party-A 422A.

In accordance with an embodiment, the game sorting unit 208 may then sort the games in the second set of games 414. The games in the second set of games 414 may be sorted based on an alphabetical order of game title names of the games in the second set of games 414. Further, the presence of the one or more other users 108b to 108d associated with the games in the second set of games 414 may be displayed in the alphabetical order of user's online identifier. For example, the game-C 424 and the game-D 426, may be sorted based on the alphabetical order of name of the games.

The game sorting unit 208 may then sort the games in the third set of games based on the number of online users in each game and/or community and/or alphabetical order of game and/or community name. The game sorting unit 208 may place the third set of games 416 at the bottom of the sorted order as one or more communities, such as the community-B 428 and the community-C 430 may not be associated with any gameplay. The game sorting unit 208 may further be configured to sort the one or more communities, such as the community-B 428 and the community-C 430, in an alphabetic order of community titles. As a result of the sorting operation by the server 102, it may be convenient for a player, such as the first user 108a, to find out if other players, such as the one or more other users 108b to 108d, who are visible as online are actually playing games in the online gaming environment. It may also be convenient for a player, such as the first user 108a, to find out which games are currently played by the friends of the player or other non-friend members. Such online gaming environment may provide a user-friendly, effective, and efficient environment for the gameplay of one or games with multiple users.

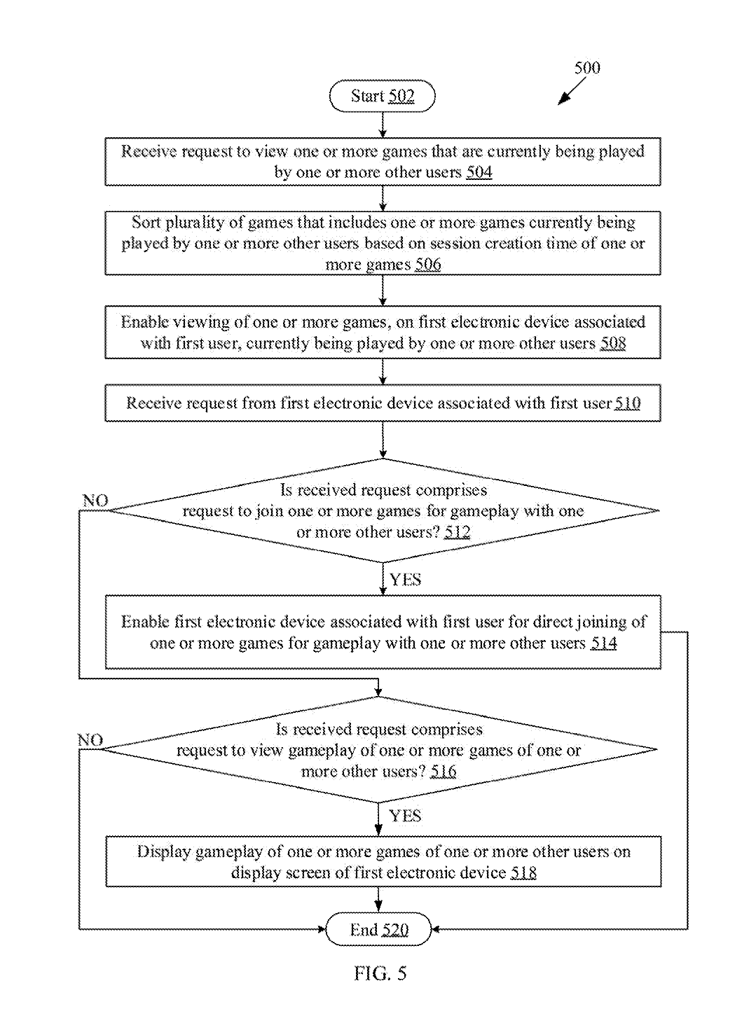

FIG. 5 is a flow chart that illustrates an information processing method for gameplay in an online gaming environment, in accordance with an embodiment of the disclosure. With reference to FIG. 5, there is shown a flow chart 500. The flow chart 500 is described in conjunction with FIGS. 1, 2, and 3. The method starts at step 502 and proceeds to step 504.

At 504, a request to view one or more games that are currently played by the one or more other users 108b to 108d may be received. In accordance with an embodiment, the processor 202 may be configured to receive the request from one of the plurality of electronic devices 104, such as the first electronic device 104a associated with the first user 108a, via the communication network 106. The received request may comprise a request to view the one or more games that are currently played by the one or more other users 108b to 108d on their respective one or more other electronic devices 104b to 104d.

At step 506, a plurality of games that includes the one or more games currently played by the one or more other users 108b to 108d are sorted based on a session creation time of the one or more games. In accordance with an embodiment, the game sorting unit 208 may be configured to sort the plurality of games. The game sorting unit 208 may sort the plurality of games based on the session creation time of each of the plurality of games, as described in FIG. 2 and FIG. 4C, to generate a sorted order of the plurality of games.

At step 508, viewing of the one or more games currently played by the one or more other users 108b to 108d may be enabled on the first electronic device 104a associated with the first user 108a. The processor 202 may be configured to enable the viewing of the one or more games on the first electronic device 104a. The plurality of games that also includes the one or more games may be displayed in a sorted order. The processor 202 may be further configured to display additional information associated with the one or more games. The additional information may include a list of users in gameplay of the one or more games, a current stage in the gameplay of the one or more games, and a total count of users in the gameplay of the one or more games. The additional information may further include an online status and progress of the one or more other users 108b to 108d in the gameplay of the one or more games, and one or more communities associated with the first user 108a.

At step 510, a request may be received from the first electronic device 104a associated with the first user 108a. The processor 202 may be configured to receive the request from the first electronic device 104a via the communication network 106.

At step 512, it may be determined whether the received request comprises a request to join the one or more games for gameplay with the one or more other users 108b to 108d. In accordance with an embodiment, the processor 202 may be further configured to perform a check to determine whether the received request comprises a request to join the one or more games for the gameplay with the one or more other users 108b to 108d. For instance, in an event that the received request comprises the request to join the one or more games, control passes to 514. In another instance, in an event that the received request does not comprise the request to join the one or more games for the gameplay with the one or more other users 108b to 108d, control passes to 516.

At step 514, the first electronic device 104a associated with the first user 108a may be enabled for direct joining of the one or more games for the gameplay with the one or more other users 108b to 108d. The processor 202 may enable the direct joining of the one or more games by the first electronic device 104a. The processor 202 may enable the direct joining of the one or more games without requiring any input from the one or more other users 108b to 108d. Further, the processor 202 may establish a game session between the first electronic device 104a and the one or more other electronic devices 104b to 104d associated with the one or more other users 108b to 108d for the gameplay. Thereafter, based on the established game session, the first user 108a may play the one or more games with the one or more other users 108b to 108d on the first electronic device 104a over the communication network 106. Control may pass to end 520.

At step 516, it may be determined whether the received request comprises a request to view the gameplay of the one or more games of the one or more other users 108b to 108d. The processor 202 may be further configured to perform a check to determine whether the received request comprises the request to view the gameplay of the one or more games of the one or more other users 108b to 108d. In the event that the received request comprises the request to view the gameplay of the one or more games of the one or more other users 108b to 108d, control passes to 518. In another instance, in an event that the received request does not comprise the request to view the gameplay of the one or more games of the one or more other users 108b to 108d, control passes to end 520.

At step 518, the gameplay of the one or more games of the one or more other users 108b to 108d may be displayed on the display screen 308 of the first electronic device 104a. The processor 202 may display the gameplay of the one or more games of the one or more other users 108b to 108d as a screenshot, a broadcast video, or a specific peer-to-peer video, on the display screen 308 of the first electronic device 104a. Control passes to end 520.

Various embodiments of the disclosure encompass numerous advantages that includes an information processing server and method for gameplay of one or more games. The information processing server and method for gameplay overcomes problems experienced by users in conventional gaming systems. Currently, multiple to and fro requests may be routed from a client device to a gaming server to a target client device to enable to a user to join a game in an online gaming environment. Further, the user may need to begin the gameplay with another user from the start of the game. Such to and fro request may interrupt the gameplay of the one or more other that may increase dissatisfaction and annoyance among users associated with the game. In contrast, the disclosed information processing server, such as the server 102, enables the first electronic device 104a to directly join a game of choice, such as the second game 406a, for the gameplay with the one or more other users 108b to 108d. For instance, the first user 108a may directly join the second game 406a from the current position or stage of the second game 406a as currently played by the one or more other users 108b to 108d. For the direct joining of the game, a user input from the target client device, such as second electronic device 104b, may not be required. Hence, the gameplay of the one or more other users may not be interrupted. In another example, the first user 108a, by use of the UI 402, may be able to see at a glance what other users, such as friends or friends circle members, are currently doing in the context of a game. The UI 402 may provide a platform to the first user 108a to quickly interact with other users. Further, as a result of the sorting operation performed by the server 102, it may be convenient for a player, such as the first user 108a, to find out if other players, such as the one or more other users 108b to 108d, who are visible as online are actually playing games in the online gaming environment. It may also be convenient for a player, such as the first user 108a, to find out which games are currently played by the friends of the player or other non-friend members. The operations performed by the processor 202 and/or the game sorting unit 208, may improve the functioning of the server 102 to provide a friendly, effective, and efficient environment for the gameplay.

In accordance with an embodiment of the disclosure, an information processing server is disclosed. The information processing server, such as the server 102 (shown in FIG. 1), may comprise one or more circuits, such as the processor 202 and the game sorting unit 208 (shown in FIG. 2), that may be configured to enable viewing of a game, on the first electronic device 104a associated with the first user 108a, currently played by one or more other users 108b to 108d associated with one or more other electronic devices 104b to 104d. The one or more circuits may enable direct joining of the game, such as the second game 406a, by the first electronic device 104a for gameplay with the one or more other users 108b to 108d associated with the one or more other electronic devices 104b to 104d. The direct joining may be enabled based on a request received from the first user 108a by the first electronic device 104a.

Various embodiments of the disclosure may provide a non-transitory computer-readable medium and/or storage medium, wherein there is stored thereon, a machine code and/or a set of instructions with at least one code section executable by a machine and/or a computer to enable direct joining of a game for gameplay. The at least one code section in the server 102 may cause the machine and/or computer to perform the operations that comprise enablement of viewing of a game, on the first electronic device 104a associated with the first user 108a, currently played by one or more other users 108b to 108d associated with one or more other electronic devices 104b to 104d. A direct joining of the game, such as the second game 406a, by the first electronic device 104a for gameplay with the one or more other users 108b to 108d associated with the one or more other electronic devices 104b to 104d, may be enabled. The direct joining may be enabled based on a request received by the server 102 from the first user 108a by the first electronic device 104a.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A server, comprising:
one or more circuits communicatively coupled to a plurality of electronic devices, said one or more circuits being configured to:
enable a game to be viewed on a first electronic device associated with a first user, wherein one or more other users associated with one or more other electronic devices are currently engaged in play of said game; and
enable said first electronic device to directly join said game for gameplay with said one or more other users associated with said one or more other electronic devices, based on a request received from said first user by said first electronic device.

2. The server according to claim 1, wherein said first electronic device directly joins said game for said gameplay independent of any required input from said one or more other users.

3. The server according to claim 1, wherein:
said received request comprises a request to join said game for said gameplay with said one or more other users; and
said one or more circuits are further configured to establish a game session between said first electronic device and said one or more other electronic devices for said gameplay based on said request to join said game.

4. The server according to claim 1, wherein said one or more circuits are further configured to:
receive a viewing request to view said gameplay of said game of said one or more other users; and
display said gameplay of said game of said one or more other users on said first electronic device based on said viewing request.

5. The server according to claim 4, wherein said gameplay of said game of said one or more other users on said first electronic device is displayed as a screenshot.

6. The server according to claim 4, wherein said gameplay of said game of said one or more other users on said first electronic device is displayed as broadcast video.

7. The server according to claim 1, wherein said one or more circuits are further configured to indicate an online status of said one or more other users associated with said game on said first electronic device.

8. The server according to claim 1, wherein said one or more circuits are further configured to indicate a progress of said one or more other users associated with said game on said first electronic device.

9. The server according to claim 1, wherein said one or more circuits are further configured to display a community associated with said first user on said first electronic device.

10. The server according to claim 1, wherein said one or more circuits are further configured to sort a plurality of games based on a session creation time of said plurality of games.

11. The server according to claim 1, wherein said one or more circuits are further configured to provide parental control options for displaying content of said game on said first electronic device.

12. A method, comprising:
enabling, by one or more circuits in a server communicatively coupled to a plurality of electronic devices, viewing of a game, on a first electronic device associated with a first user, currently being played by one or more other users associated with one or more other electronic devices; and
enabling, by said one or more circuits, direct joining of said game by said first electronic device for gameplay with said one or more other users associated with said one or more other electronic devices, based on a request received from said first user by said first electronic device.

13. The method according to claim 12, wherein said direct joining occurs independent of requiring any input from said one or more other users.

14. The method according to claim 12, wherein:
said received request comprises a request to join said game for said gameplay with said one or more other users; and
establishing, by said one or more circuits, a game session between said first electronic device and said one or more other electronic devices for said gameplay based on said request to join said game.

15. The method according to claim 12, further comprising:
receiving, by said one or more circuits, a viewing request to view said gameplay of said game of said one or more other users; and
displaying, by said one or more circuits, said gameplay of said game of said one or more other users on said first electronic device based on said viewing request.

16. The method according to claim 15, wherein said gameplay of said game of said one or more other users on said first electronic device is displayed as a screenshot.

17. The method according to claim 15, wherein said gameplay of said game of said one or more other users on said first electronic device is displayed as broadcast video.

18. The method according to claim 12, further comprising indicating, by said one or more circuits, an online status of said one or more other users associated with said game on said first electronic device.

19. The method according to claim 12, further comprising indicating, by said one or more circuits, a progress of said one or more other users associated with said game on said first electronic device.

20. The method according to claim 12, further comprising displaying, by said one or more circuits, a community associated with said first user on said first electronic device.

21. The method according to claim 12, further comprising sorting, by said one or more circuits, a plurality of games based on a session creation time of said plurality of games.

22. The method according to claim 12, further comprising providing, by said one or more circuits, parental control options for displaying content of said game on said first electronic device.
